(19) United States
(12) Patent Application Publication
(10) Pub. No.: US 2024/0184189 A1
(43) Pub. Date: Jun. 6, 2024

(54) WAVELENGTH CONVERSION ELEMENT, LIGHT SOURCE DEVICE, AND PROJECTOR

(71) Applicant: SEIKO EPSON CORPORATION, Tokyo (JP)

(72) Inventor: Tomohiro YOKOO, Matsumoto-shi (JP)

(73) Assignee: SEIKO EPSON CORPORATION, Tokyo (JP)

(21) Appl. No.: 18/528,919

(22) Filed: Dec. 5, 2023

(30) Foreign Application Priority Data
Dec. 6, 2022 (JP) 2022-194723

(51) Int. Cl. G03B 21/20

(52) U.S. Cl. CPC G03B 21/204; G03B 21/2066

(57) ABSTRACT

A wavelength conversion element of the present disclosure includes a wavelength conversion layer having a first surface entered by a first light in a first wavelength band and a second surface located at an opposite side to the first surface, and converting the first light into a second light in a second wavelength band, a first substrate facing the first surface and transmitting the first light, and a second substrate facing the second surface and transmitting the second light. The wavelength conversion layer and the first substrate are not in optical contact, and the wavelength conversion layer and the second substrate are not in optical contact.

The present application is based on, and claims priority from JP Application Serial Number 2022-194723, filed Dec. 6, 2022, the disclosure of which is hereby incorporated by reference herein in its entirety.

### BACKGROUND

### 1. Technical Field

The present disclosure relates to a wavelength conversion element, a light source device, and a projector.

### 2. Related Art

As a light source device used for a projector, a light source device using fluorescence emitted from a phosphor by irradiation of the phosphor with an excitation light output from a light emitting element is proposed.

JP-A-2016-170326 discloses a phosphor wheel for projector including a stacking structure having a phosphor layer and a first glass layer and a second glass layer sandwiching the phosphor layer from both sides and being rotatable. JP-A-2016-170326 discloses that the first glass layer, the phosphor layer, and the second glass layer are stacked and sintered, and thereby, these three layers may be integrated and the mechanical strength of the phosphor wheel may be increased.

In the phosphor wheel of JP-A-2016-170326, the phosphor layer is integrated with the two glass layers, and the fluorescence generated inside of the phosphor layer enters the respective two glass layers. The fluorescence entering each glass layer spreads and propagates in the planar direction of each glass layer, and then, is output from the glass layer. In this case, the fluorescence is output from a region wider toward the outside than the original light emission region of the phosphor layer. As a result, there is a problem that the fluorescence entering a downstream optical system of the phosphor wheel decreases and use efficiency of the fluorescence is lower. As above, the phosphor wheel is explained as an example, however, the above described problem is common to other wavelength conversion elements than the phosphor wheel.

### SUMMARY

In order to solve the above described problem, a wavelength conversion element according to an aspect of the present disclosure includes a wavelength conversion layer having a first surface entered by a first light in a first wavelength band and a second surface located at an opposite side to the first surface, and converting the first light into a second light in a second wavelength band different from the first wavelength band, a first substrate placed to face the first surface and transmitting the first light, and a second substrate placed to face the second surface and transmitting the second light. The wavelength conversion layer and the first substrate are not in optical contact, and the wavelength conversion layer and the second substrate are not in optical contact.

A light source device according to an aspect of the present disclosure includes the wavelength conversion element according to the aspect of the present disclosure, and a light emitting element outputting the first light to be entered into the wavelength conversion element.

A projector according to an aspect of the present disclosure includes the light source device according to the aspect of the present disclosure, a light modulation device modulating a light containing the second light output from the light source device according to image information, and a projection optical device projecting the light modulated by the light modulation device.

### BRIEF DESCRIPTION OF THE DRAWINGS

FIG. 1 is a schematic configuration diagram of a projector of a first embodiment.

FIG. 2 is a schematic configuration diagram of a light source device of the first embodiment.

FIG. 3 is a sectional view of a wavelength conversion element of the first embodiment.

FIG. 4 is an enlarged sectional view of a wavelength conversion layer.

FIG. 5 shows a relationship between a distance between the wavelength conversion layer and a substrate and a temperature of the wavelength conversion layer.

FIG. 6 is a sectional view of a wavelength conversion element of a second embodiment.

FIG. 7 is a sectional view of a wavelength conversion element of a third embodiment.

FIG. 8 is a sectional view of a wavelength conversion element of a fourth embodiment.

FIG. 9 is a plan view of a wavelength conversion element of a fifth embodiment.

FIG. 10 is a sectional view of the wavelength conversion element along line X-X in FIG. 9.

FIG. 11 is a sectional view of a wavelength conversion element of a sixth embodiment.

### DESCRIPTION OF EMBODIMENTS

### First Embodiment

As below, a first embodiment of the present disclosure will be explained in detail with reference to the drawings.

The drawings used in the following explanation may enlarge and show characteristic parts for clarification of characteristics, and ratios among the dimensions of the respective component elements etc. are not necessarily the same as the real ones.

A projector of the embodiment is an example of a projector using three transmissive liquid crystal light valves.

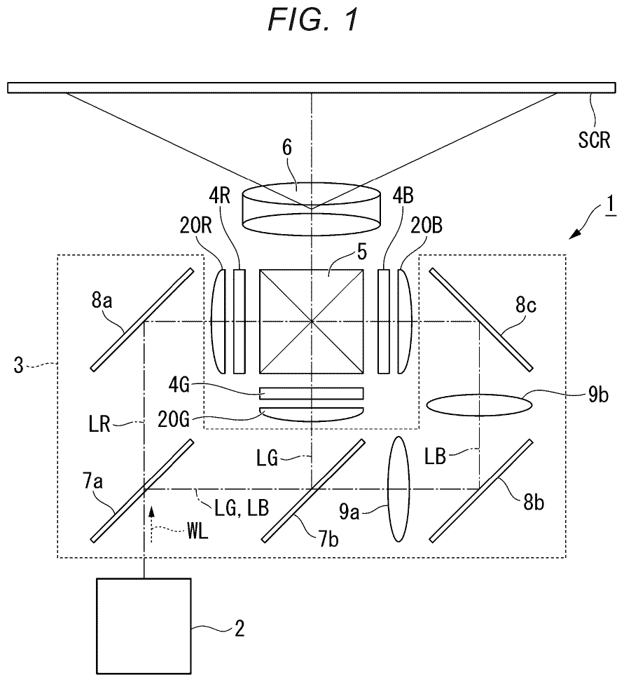

FIG. 1 is a schematic configuration diagram of the projector of the embodiment.

As shown in FIG. 1, a projector 1 includes a light source device 2, a color separation system 3, a light modulation device 4R, a light modulation device 4G, a light modulation device 4B, a light combining system 5, and a projection optical device 6. The light source device 2 radiates a white illumination light WL. The color separation system 3 separates the illumination light WL from the light source device 2 into a red light LR, a green light LG, and a blue light LB. The respective light modulation device 4R, light modulation device 4G, and light modulation device 4B modulate the respective color lights according to image information and form image lights of the respective colors. The light combining system 5 combines the image lights of the respective colors output from the respective light modulation devices 4R, 4G, 4B. The projection optical device 6 projects an image light formed by combination by the light combining system 5 toward a screen SCR.

The light source device 2 outputs the white illumination light (white light) WL formed by combination of a part of the blue light output without wavelength conversion of the blue light output from a semiconductor laser and a yellow fluorescent light generated by wavelength conversion of the excitation light by the phosphor. The light source device 2 outputs the illumination light WL having a substantially homogeneous illuminance distribution toward the color separation system 3. The specific configuration of the light source device 2 will be described later.

The color separation system 3 includes a first dichroic mirror 7a, a second dichroic mirror 7b, a first reflection mirror 8a, a second reflection mirror 8b, a third reflection mirror 8c, a first relay lens 9a, and a second relay lens 9b.

The first dichroic mirror 7a separates the illumination light WL output from the light source device 2 into a light as a mixture of the red light LR, the green light LG, and the blue light LB. For the separation, the first dichroic mirror 7a transmits the red light LR and reflects the green light LG and the blue light LB. The second dichroic mirror 7b separates a light as a mixture of the green light LG and the blue light LB into the green light LG and the blue light LB. For the separation, the second dichroic mirror 7b reflects the green light LG and transmits the blue light LB.

The first reflection mirror 8a is placed in an optical path of the red light LR and reflects the red light LR transmitted through the first dichroic mirror 7a toward the light modulation device 4R. The second reflection mirror 8b and the third reflection mirror 8c are placed in an optical path of the blue light LB and guide the blue light LB transmitted through the second dichroic mirror 7b to the light modulation device 4B. The second dichroic mirror 7b reflects the green light LG toward the light modulation device 4G.

The first relay lens 9a and the second relay lens 9b are placed downstream of the second dichroic mirror 7b in the optical path of the blue light LB. The first relay lens 9a and the second relay lens 9b compensate for a light loss of the blue light LB due to the longer optical path length of the blue light LB than the optical path length of the red light LR and the optical path length of the green light LG.

The respective light modulation device 4R, light modulation device 4G, and light modulation device 4B include liquid crystal panels. The light modulation device 4R modulates the red light LR according to the image information and forms an image light corresponding to the red light LR. The light modulation device 4G modulates the green light LG according to the image information and forms an image light corresponding to the green light LG. The light modulation device 4B modulates the blue light LB according to the image information and forms an image light corresponding to the blue light LB. At light incident sides and light exiting sides of the respective light modulation device 4R, light modulation device 4G, and light modulation device 4B, polarizers (not shown) are respectively placed.

At the light incident side of the light modulation device 4R, a field lens 20R parallelizing the red light LR entering the light modulation device 4R is provided. At the light incident side of the light modulation device 4G, a field lens 20G parallelizing the green light LG entering the light modulation device 4G is provided. At the light incident side of the light modulation device 4B, a field lens 20B parallelizing the blue light LB entering the light modulation device 4B is provided.

The light combining system 5 includes a cross dichroic prism. The light combining system 5 combines the image lights of the respective colors output from the respective light modulation device 4R, light modulation device 4G, and light modulation device 4B and outputs the combined image light toward the projection optical device 6.

The projection optical device 6 includes a plurality of projection lenses. The projection optical device 6 enlarges and projects the image light combined by the light combining system 5 toward the screen SCR. Thereby, an enlarged color picture (image) is displayed on the screen SCR.

As below, the light source device 2 of the embodiment will be explained.

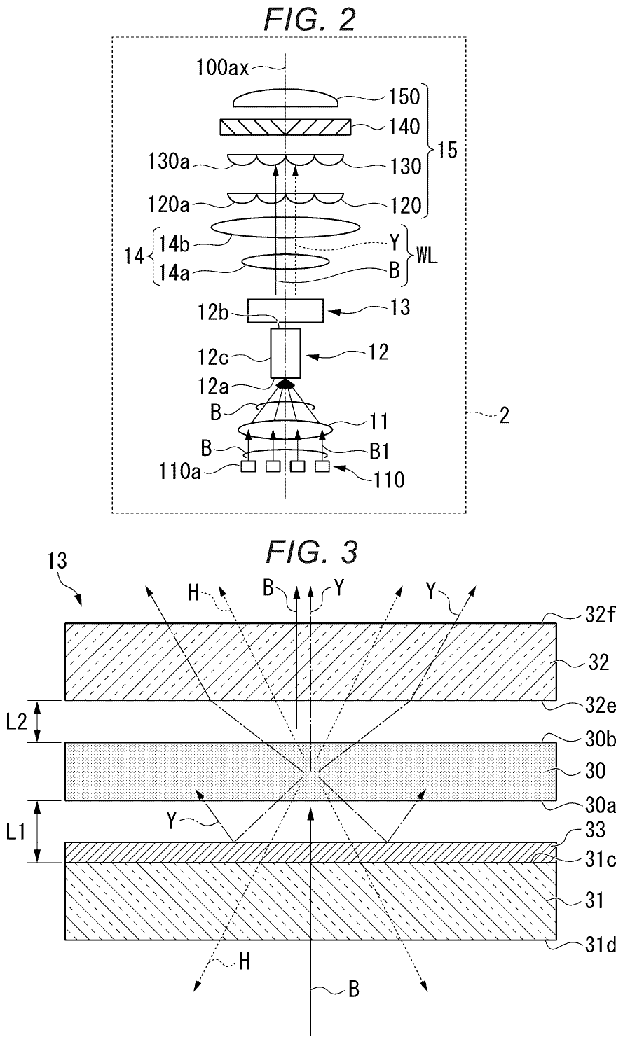

FIG. 2 shows a schematic configuration of the light source device 2.

As shown in FIG. 2, the light source device 2 includes a light source unit 110, a collecting lens 11, a light guiding member 12, a wavelength conversion element 13, a pickup system 14, and an optical integration system 15.

The light source unit 110 has a plurality of light emitting elements 110a outputting blue lights B1 including laser beams. The light emitting elements 110a include semiconductor lasers. A first wavelength band of the blue light B1 output from the light emitting element 110a is e.g., a range from 445 nm to 465 nm and a peak wavelength is e.g., 455 nm. The plurality of light emitting elements 110a are arranged in an array form within one plane orthogonal to an illumination optical axis 100ax. The center axis of the illumination light WL output from the light source device 2 is defined as the illumination optical axis 100ax. The number of the light emitting elements 110a is not particularly limited. Further, the wavelength band of the blue light B1 output from the light emitting element 110a is not limited to that described as above.

The light source unit 110 of the embodiment outputs a blue light B including a pencil of light containing the plurality of blue lights B1 in the first wavelength band toward the wavelength conversion element 13. The blue light B of the embodiment corresponds to a first light in Claims.

The collecting lens 11 is provided at the light exiting side of the light source unit 110. The collecting lens 11 includes a convex lens. The collecting lens 11 collects and enters the blue light B output from the light source unit 110 into the light guiding member 12.

The light guiding member 12 has a light incident face 12a, a light exiting face 12b, and a side face 12c. The light incident face 12a is an end face entered by the blue light B collected by the collecting lens 11. The light exiting face 12b is an end face opposite to the light incident face 12a and outputs the blue light B propagating inside of the light guiding member 12. The side face 12c is a face crossing the light incident face 12a and the light exiting face 12b.

The light guiding member 12 propagates the blue light B entering the light guiding member 12 from the light incident face 12a by total reflection by the side face 12c and outputs a part of the blue light B from the light exiting face 12b. The light guiding member 12 includes a rod lens extending in the long axis direction. The light guiding member 12 has a quadrangular prism shape having a section area orthogonal to the center axis that remains unchanged from the light incident face 12a toward the light exiting face 12b.

The light guiding member 12 includes a light-transmissive member of e.g., borosilicate glass such as BK7, quartz, synthetic quartz, crystal, or sapphire. The light guiding member 12 is formed using e.g., quartz having a property of absorbing a smaller amount of the blue light B in the first wavelength band. Thereby, the light guiding member 12 may efficiently propagate and guide the blue light B to the wavelength conversion element 13.

The blue light B entering the light guiding member 12 propagates while totally reflected inside of the light guiding member 12 and is output from the light exiting face 12b in a condition with increased homogeneity of the illuminance distribution. The blue light B with the homogeneity of the illuminance distribution increased by the light guiding member 12 enters the wavelength conversion element 13. The wavelength conversion element 13 is excited by the blue light B and generates and outputs a fluorescence Y. The fluorescence Y of the embodiment corresponds to a second light in Claims.

A part of the blue light B entering the wavelength conversion element 13 is transmitted through the wavelength conversion element 13 and output. That is, the wavelength conversion element 13 outputs the white illumination light WL formed by combination of the part of the blue light B and the fluorescence Y. The configuration of the wavelength conversion element 13 will be described later.

The pickup system 14 includes a first lens 14a and a second lens 14b. The pickup system 14 substantially parallelizes the illumination light WL output from the wavelength conversion element 13. The respective first lens 14a and second lens 14b include convex lenses. The number of lenses forming the pickup system 14 is not particularly limited.

The optical integration system 15 includes a first lens array 120, a second lens array 130, a polarization conversion element 140, and a superimposing lens 150. The first lens array 120 has a plurality of first lenses 120a dividing the illumination light WL output from the pickup system 14 into a plurality of partial luminous fluxes. The plurality of first lenses 120a are arranged in a matrix form within a plane orthogonal to the illumination optical axis 100ax.

The second lens array 130 has a plurality of second lenses 130a corresponding to the plurality of first lenses 120a of the first lens array 120. The second lens array 130 focuses images of the respective first lenses 120a of the first lens array 120 near image formation areas of the light modulation device 4R, the light modulation device 4G, and the light modulation device 4B with the superimposing lens 150. The plurality of second lenses 130a are arranged in a matrix form within a plane orthogonal to the illumination optical axis 100ax.

The polarization conversion element 140 converts the illumination light WL output from the second lens array 130 into a linearly-polarized light having a predetermined polarization direction. The polarization conversion element 140 includes a reflection layer, a polarization separation layer, and a retardation film (not shown).

The superimposing lens 150 collects and superimposes the respective partial luminous fluxes output from the polarization conversion element 140 near the image formation areas of the light modulation device 4R, the light modulation device 4G, and the light modulation device 4B. The first lens array 120, the second lens array 130, and the superimposing lens 150 form the optical integration system 15 homogenizing the intensity distribution of the light from the wavelength conversion element 13.

As below, the wavelength conversion element 13 will be explained.

FIG. 3 is a sectional view showing a schematic configuration of the wavelength conversion element 13.

As shown in FIG. 3, the wavelength conversion element 13 includes a wavelength conversion layer 30, a first substrate 31, a second substrate 32, and a reflection layer 33. Note that the wavelength conversion element 13 may include a holding member holding the wavelength conversion layer 30, the first substrate 31, and the second substrate 32.

The wavelength conversion layer 30 contains a phosphor and converts the blue light B having the first wavelength band into the fluorescence Y having a second wavelength band different from the first wavelength band. The wavelength conversion layer 30 has a first surface 30a entered by the blue light B and a second surface 30b located at the opposite side to the first surface 30a.

The wavelength conversion layer 30 contains a ceramic phosphor of a polycrystalline phosphor that wavelength-converts the blue light B into the fluorescence Y. The second wavelength band of the fluorescence Y is e.g., a yellow wavelength band from 490 nm to 750 nm. That is, the fluorescence Y is a yellow fluorescence containing a red light component and a green light component. The wavelength conversion layer 30 may contain a single-crystalline phosphor in place of the polycrystalline phosphor. Or, the wavelength conversion layer 30 may include a fluorescent glass. Or, the wavelength conversion layer 30 may include a material in which many phosphor particles are dispersed in a binder of glass or resin. The wavelength conversion layer 30 including the material may convert the blue light B into the fluorescence Y.

Specifically, the material of the wavelength conversion layer 30 includes e.g., a yttrium aluminum garnet (YAG) phosphor. YAG:Ce containing cerium (Ce) as an activator agent is taken as an example. As the material of the wavelength conversion layer 30, a material formed by mixing and solid-phase reaction of raw material powder containing component elements of Y₂O₃, Al₂O₃, CeO₃, etc., Y—Al—O amorphous particles obtained by a wet process including a coprecipitation process and a sol-gel process, YAG particles obtained by a gas-phase process including a spray drying process, a flame pyrolysis process, and a thermal plasma process, or the like is used.

The first substrate 31 is placed to face the first surface 30a of the wavelength conversion layer 30 and transmits the blue light B. The first substrate 31 has a third surface 31c facing the first surface 30a of the wavelength conversion layer 30 and a fourth surface 31d located at the opposite side to the third surface 31c. The material of the first substrate 31 is not particularly limited as long as the material has light transmissivity that may transmit the blue light B, but e.g., glass, quartz, sapphire, YAG, SiC, or diamond is used. The first substrate 31 also functions as a heat dissipation member that releases heat transmitted from the wavelength conversion layer 30 to the exterior space.

The second substrate 32 is placed to face the second surface 30b of the wavelength conversion layer 30 and transmits the fluorescence Y and the blue light B. The second substrate 32 has a fifth surface 32e facing the second surface 30b of the wavelength conversion layer 30 and a sixth surface 32f located at the opposite side to the fifth surface 32e. The material of the second substrate 32 is not particularly limited as long as the material has light transmissivity that may transmit the fluorescence Y and the blue light B, but e.g., glass, quartz, sapphire, YAG, SiC, or diamond is used like the first substrate 31. The material of the second substrate 32 may be the same as the material of the first substrate 31 or different from the material of the first substrate 31. The second substrate 32 also functions as a heat dissipation member that releases heat transmitted from the wavelength conversion layer 30 to the exterior space like the first substrate 31.

It is preferable that the refractive index of the second substrate 32 is equal to or larger than 1.5. According to the configuration, a refraction angle when the fluorescence Y enters the second substrate 32 from the fifth surface 32e is larger than that when the refractive index of the second substrate 32 is smaller than 1.5. As a result, spreading of the fluorescence Y output from the sixth surface 32f may be made smaller. Or, if the spreading of the fluorescence Y output from the sixth surface 32f equal to that when the refractive index of the second substrate 32 is smaller than 1.5 is acceptable, the second substrate 32 may be made thicker and the heat dissipation of the second substrate 32 may be increased. In the viewpoint, as the material of the second substrate 32, sapphire having the refractive index 1.76, diamond having the refractive index 2.4, SiC having the refractive index 2.6, or the like is preferably used.

It is desirable that thermal conductivity of the first substrate 31 is larger than thermal conductivity of the wavelength conversion layer 30. According to the configuration, when the heat of the wavelength conversion layer 30 is transmitted to the first substrate 31, the heat may be efficiently released from the fourth surface 31d to the exterior space. Similarly, it is desirable that thermal conductivity of the second substrate 32 is larger than thermal conductivity of the wavelength conversion layer 30. According to the configuration, when the heat of the wavelength conversion layer 30 is transmitted to the second substrate 32, the heat may be efficiently released from the sixth surface 32f to the exterior space.

The reflection layer 33 is provided between the wavelength conversion layer 30 and the first substrate 31. The reflection layer 33 includes a dielectric multilayer film in which a plurality of films having different refractive indices from one another are stacked and transmits a light in a blue wavelength band and reflects a light in a yellow wavelength band. That is, the reflection layer 33 functions as a dichroic layer transmitting the blue light B and reflecting the fluorescence Y. In the case of the embodiment, the reflection layer 33 is provided on the third surface 31c of the first substrate 31 facing the first surface 30a of the wavelength conversion layer 30. According to the configuration, the third surface 31c of the first substrate 31 has higher flatness than that of the first surface 30a of the wavelength conversion layer 30, and thereby the reflection layer 33 having a desired property is easily formed.

The reflection layer 33 may be provided on the first surface 30a of the wavelength conversion layer 30. According to the configuration, the fluorescence Y is not output from the first surface 30a of the wavelength conversion layer 30 to the exterior space, but reflected by the reflection layer 33, and thereby the loss of the fluorescence Y may be minimized. Or, the reflection layer 33 may be formed on another substrate and placed between the wavelength conversion layer 30 and the first substrate 31.

The fluorescence Y is isotropically emitted from the phosphor contained in the wavelength conversion layer 30 and travels in all directions. Accordingly, a part of the fluorescence Y is output from the second surface 30b of the wavelength conversion layer 30 and another part of the fluorescence Y is output from the first surface 30a of the wavelength conversion layer 30. In the case of the embodiment, as will be described later, the amount of the fluorescence Y output from the first surface 30a of the wavelength conversion layer 30 is smaller, however, the reflection layer 33 is provided between the wavelength conversion layer 30 and the first substrate 31 and the fluorescence Y output from the first surface 30a of the wavelength conversion layer 30 is reflected by the reflection layer 33 and enters the wavelength conversion layer 30 again and is output from the second surface 30b of the wavelength conversion layer 30. Thereby, the fluorescence Y returning to the side of the light source unit 110 may be reduced and the use efficiency of the fluorescence Y may be increased.

The wavelength conversion layer 30 and the first substrate 31 are not in optical contact. Further, the wavelength conversion layer 30 and the second substrate 32 are not in optical contact. “Not in optical contact” in the specification means that, regardless of whether one member and the other member are partially in physical contact, a light traveling inside of the one member does not propagate to the other member.

Specifically, the wavelength conversion layer 30 and the first substrate 31 are apart from each other. The wavelength conversion layer 30 and the second substrate 32 are apart from each other. When a distance between the wavelength conversion layer 30 and the first substrate 31 is L1 and a distance between the wavelength conversion layer 30 and the second substrate 32 is L2, it is desirable that relationships 0 μm<L1≤50 μm and 0 μm<L2≤50 μm are satisfied. The distance L1 and the distance L2 may be the same as each other or different from each other. The ground for the above described numerical values will be described later.

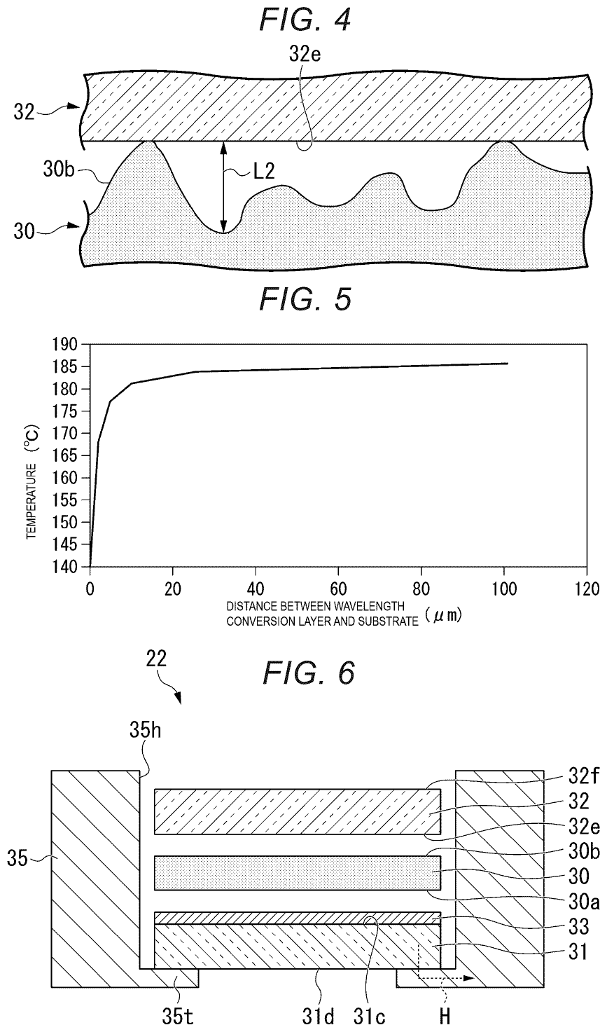

FIG. 4 is an enlarged sectional view of the second surface 30b of the wavelength conversion layer 30. Though not illustrated, the first surface 30a of the wavelength conversion layer 30 has the same configuration as the second surface 30b.

In a case of a wavelength conversion layer having a normal light scattering property, the first surface 30a and the second surface 30b of the wavelength conversion layer 30 have concavities and convexities having random heights and shapes. Arithmetic mean roughness Ra of the first surface 30a and the second surface 30b is generally 0<Ra<1 μm. Therefore, regarding the example in FIG. 4, of the second surface 30b of the wavelength conversion layer 30, the top parts of the higher convex portions contact the fifth surface 32e of the second substrate 32, however, the top parts of the many lower convex portions do not contact the fifth surface 32e of the second substrate 32. Accordingly, even when a part of the second surface 30b of the wavelength conversion layer 30 physically contacts the fifth surface 32e of the second substrate 32, an air layer intervenes between the second surface 30b of the wavelength conversion layer 30 and the fifth surface 32e of the second substrate 32. Therefore, the wavelength conversion layer 30 and the second substrate 32 are not in optical contact.

In the specification, the distance L2 is a distance between the bottom part of the lowest concave portion of the second surface 30b of the wavelength conversion layer 30 and the fifth surface 32e of the second substrate 32 in a direction along the incident direction of the blue light B entering the wavelength conversion element. Similarly, the distance L1 is a distance between the bottom part of the lowest concave portion of the first surface 30a of the wavelength conversion layer 30 and the third surface 31c of the first substrate 31 in the direction along the incident direction of the blue light B entering the wavelength conversion element. That is, of the plurality of distances different depending on the location, the largest distances are defined as the distances L1 and L2. Therefore, when the relationships 0 μm<L1≤50 μm and 0 μm<L2≤50 μm are satisfied, the relationships are satisfied with respect to all distances.

The inventor thought that the respective first substrate 31 and second substrate 32 and the wavelength conversion layer 30 are not brought into optical contact and the amounts of fluorescence Y propagating from the wavelength conversion layer 30 to the respective substrates 31, 32 are reduced, and thereby, spreading of the fluorescence Y may be suppressed and lowering of the use efficiency of the fluorescence Y may be suppressed. However, when the distances between the wavelength conversion layer 30 and the respective substrates 31, 32 are too large, the heat generated in the wavelength conversion layer 30 is harder to be transmitted to the respective substrates 31, 32 and the temperature of the wavelength conversion layer 30 may rise. As a result, a failure that the wavelength conversion efficiency becomes lower, the wavelength conversion layer 30 is damaged, or the like may be caused.

Accordingly, the inventor performs a simulation of examining temperature changes of the wavelength conversion layer with distance changes between the wavelength conversion layer and the substrate.

FIG. 5 shows a simulation result as a graph showing a relationship between the distance between the wavelength conversion layer and the substrate and the temperature of the wavelength conversion layer. The horizontal axis of the graph is the distance (μm) between the wavelength conversion layer and the substrate. The vertical axis of the graph is the temperature (° C.) of the wavelength conversion layer.

As simulation conditions, the material of the wavelength conversion layer was YAG:Ce and the material of the substrate was sapphire. Air having thermal conductivity 0.02 W/m·K intervened between the wavelength conversion layer and the substrate. The wavelength conversion layer was set as a heat generation source without contact with the substrate.

As shown in FIG. 5, as the distance between the wavelength conversion layer and the substrate is increased from 0 μm, the temperature of the wavelength conversion layer tends to abruptly rise from 140° C. When the distance between the wavelength conversion layer and the substrate is set to about 30 μm, the temperature rise of the wavelength conversion layer is gradual. When the distance between the wavelength conversion layer and the substrate is larger than 50 μm, the temperature of the wavelength conversion layer is substantially constant at about 185° C. That is, it is found that, when the distance between the wavelength conversion layer and the substrate is larger than 50 μm, the heat generated in the wavelength conversion layer is rarely transmitted to the substrate.

From the above described simulation result, it is found that it is desirable that the distance L1 between the wavelength conversion layer 30 and the first substrate 31 and the distance L2 between the wavelength conversion layer 30 and the second substrate 32 are respectively larger than 0 μm and equal to or smaller than 50 μm. Thereby, as shown in FIG. 3, while the propagation of the fluorescence Y from the wavelength conversion layer 30 to the respective substrates 31, 32 is suppressed, heat H generated in the wavelength conversion layer 30 is transmitted to the respective substrates 31, 32, and thereby, the temperature rise of the wavelength conversion layer 30 may be suppressed.

The wavelength conversion element 13 of the embodiment does not include members for holding the distance between the wavelength conversion layer 30 and the first substrate 31 and the distance between the wavelength conversion layer 30 and the second substrate 32. However, as described above, the arithmetic mean roughness Ra of the first surface 30a and the second surface 30b of the wavelength conversion layer 30 is smaller than 1 μm and, even when the individually fabricated first substrate 31, wavelength conversion layer 30, and second substrate 32 are simply stacked, microscopic air layers intervene between the wavelength conversion layer 30 and the respective substrates 31, 32 and the relationships 0 μm<L1≤50 μm and 0 μm<L2≤50 μm are satisfied. Thereby, the respective first substrate 31 and second substrate 32 and the wavelength conversion layer 30 are not in optical contact, and the amounts of fluorescence Y respectively propagating from the wavelength conversion layer 30 to the respective first substrate 31 and second substrate 32 may be suppressed and the heat H of the wavelength conversion layer 30 may be transmitted to the respective first substrate 31 and second substrate 32.

### Effects of First Embodiment

The wavelength conversion element 13 of the embodiment includes the wavelength conversion layer 30 having the first surface 30a entered by the blue light B and the second surface 30b located at the opposite side to the first surface 30a and converting the blue light B into the fluorescence Y, the first substrate 31 placed to face the first surface 30a and transmitting the blue light B, and the second substrate 32 placed to face the second surface 30b and transmitting the fluorescence Y. The wavelength conversion layer 30 and the first substrate 31 are not in optical contact and the wavelength conversion layer 30 and the second substrate 32 are not in optical contact. Specifically, the wavelength conversion layer 30 and the first substrate 31 are apart from each other, the wavelength conversion layer 30 and the second substrate 32 are apart from each other, and the distance L1 between the wavelength conversion layer 30 and the first substrate 31 and the distance L2 between the wavelength conversion layer 30 and the second substrate 32 satisfy the relationships 0<L1≤50 μm and 0<L2≤50 μm.

According to the configuration of the embodiment, the propagation of the fluorescence Y generated in the wavelength conversion layer 30 to the first substrate 31 and the second substrate 32 is suppressed, the smaller amounts of the fluorescence Y output from the wavelength conversion layer 30 are guided in the planar directions of the respective substrates 31, 32 and the fluorescence widely spreading and output from the original light emission region of the wavelength conversion layer 30 may be suppressed. As a result, decrease of the fluorescence Y entering the optical system downstream the wavelength conversion element 13 is suppressed and the use efficiency of the fluorescence Y may be sufficiently secured. On the other hand, the heat H generated in the wavelength conversion layer 30 is transmitted to the first substrate 31 and the second substrate 32 and the temperature rise of the wavelength conversion layer 30 may be suppressed. As a result, a failure that the wavelength conversion efficiency becomes lower, the wavelength conversion layer 30 is damaged, or the like may be suppressed.

The light source device 2 of the embodiment includes the wavelength conversion element 13 of the embodiment and is excellent in use efficiency of the fluorescence Y.

The projector 1 of the embodiment includes the light source device 2 of the embodiment, and the projector with the higher efficiency may be realized.

### Second Embodiment

As below, a second embodiment of the present disclosure will be explained using the drawing.

The basic configurations of a projector and a light source device of the second embodiment are substantially the same as those of the first embodiment, but the configuration of a wavelength conversion element is different from that of the first embodiment. Accordingly, the explanation of the projector and the light source device will be omitted.

FIG. 6 is a sectional view showing a schematic configuration of a wavelength conversion element 22 of the second embodiment.

In FIG. 6, the component elements in common with the drawings used in the first embodiment have the same signs and the explanation thereof will be omitted.

As shown in FIG. 6, the wavelength conversion element 22 of the embodiment includes the wavelength conversion layer 30, the first substrate 31, the second substrate 32, the reflection layer 33, and a heat dissipation member 35.

The heat dissipation member 35 is provided to surround the wavelength conversion layer 30, the first substrate 31, the second substrate 32, and the reflection layer 33. That is, the heat dissipation member 35 has an opening portion 35h and the wavelength conversion layer 30, the first substrate 31, the second substrate 32, and the reflection layer 33 are placed inside of the opening portion 35h. The heat dissipation member 35 has a projection portion 35t in direct contact with a peripheral edge portion of the fourth surface 31d of the first substrate 31. The heat dissipation member 35 is thermally coupled to the first substrate 31 via the projection portion 35t. Thereby, part of the heat H of the wavelength conversion layer 30 is transmitted from the first substrate 31 to the heat dissipation member 35 and released from the heat dissipation member 35 to the exterior space. Therefore, it is desirable that the heat dissipation member 35 has a predetermined strength and is formed using a material having higher thermal conductivity. As the material of the heat dissipation member 35, e.g., a metal such as copper, aluminum, or stainless is used.

In the case of the embodiment, the heat dissipation member 35 is thermally coupled to the first substrate 31, but not thermally coupled to the wavelength conversion layer 30 and the second substrate 32, however, may be thermally coupled to the wavelength conversion layer 30 and the second substrate 32. That is, it is only necessary that the heat dissipation member 35 is thermally coupled to at least one of the wavelength conversion layer 30, the first substrate 31, and the second substrate 32. The rest of the configuration of the wavelength conversion element 22 is the same as that of the wavelength conversion element 13 of the first embodiment.

### Effects of Second Embodiment

Also, in the embodiment, the same effects as those of the first embodiment that the use efficiency of the fluorescence Y may be sufficiently secured by suppression of spreading of the output region of the fluorescence Y and lowering of the wavelength conversion efficiency, damage on the wavelength conversion layer 30, or the like may be suppressed by suppression of the temperature rise of the wavelength conversion layer 30 may be obtained.

Particularly, in the case of the embodiment, the wavelength conversion element 22 includes the heat dissipation member 35 thermally coupled to the first substrate 31, and thereby, the temperature rise of the wavelength conversion layer 30 may be suppressed more effectively.

### Third Embodiment

As below, a third embodiment of the present disclosure will be explained using the drawing.

The basic configurations of a projector and a light source device of the third embodiment are substantially the same as those of the first embodiment, but the configuration of a wavelength conversion element is different from that of the first embodiment. Accordingly, the explanation of the projector and the light source device will be omitted.

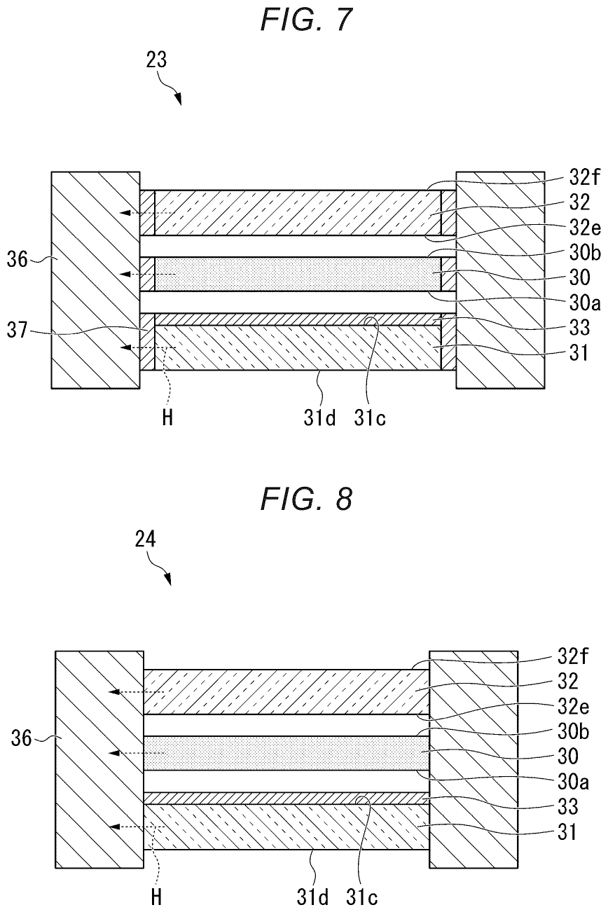

FIG. 7 is a sectional view showing a schematic configuration of a wavelength conversion element 23 of the third embodiment.

In FIG. 7, the component elements in common with the drawings used in above described embodiments have the same signs and the explanation thereof will be omitted.

As shown in FIG. 7, the wavelength conversion element 23 of the embodiment includes the wavelength conversion layer 30, the first substrate 31, the second substrate 32, the reflection layer 33, and a heat dissipation member 36.

Like the second embodiment, the heat dissipation member 36 is provided to surround the wavelength conversion layer 30, the first substrate 31, the second substrate 32, and the reflection layer 33. The heat dissipation member 36 is thermally coupled to the wavelength conversion layer 30, the first substrate 31, and the second substrate 32 via a joint member 37 having high thermal conductivity. Thereby, part of the heat H of the wavelength conversion layer 30 is transmitted from the respective wavelength conversion layer 30, first substrate 31, and second substrate 32 to the heat dissipation member 36 and released from the heat dissipation member 36 to the exterior space. As the joint member 37 having high thermal conductivity, e.g., nano silver paste is used. It is only necessary that the heat dissipation member 36 is thermally coupled to at least one of the wavelength conversion layer 30, the first substrate 31, and the second substrate 32. The rest of the configuration of the wavelength conversion element 23 is the same as that of the wavelength conversion element 13 of the first embodiment.

### Effects of Third Embodiment

Also, in the embodiment, the same effects as those of the first embodiment that the use efficiency of the fluorescence Y may be sufficiently secured by suppression of spreading of the output region of the fluorescence Y and lowering of the wavelength conversion efficiency, damage on the wavelength conversion layer 30, or the like may be suppressed by suppression of the temperature rise of the wavelength conversion layer 30 may be obtained.

Particularly, in the case of the embodiment, the wavelength conversion element 23 includes the heat dissipation member 36 thermally coupled to the respective wavelength conversion layer 30, first substrate 31, and second substrate 32, and thereby, the temperature rise of the wavelength conversion layer 30 may be suppressed more effectively.

### Fourth Embodiment

As below, a fourth embodiment of the present disclosure will be explained using the drawing.

The basic configurations of a projector and a light source device of the fourth embodiment are substantially the same as those of the first embodiment, but the configuration of a wavelength conversion element is different from that of the first embodiment. Accordingly, the explanation of the projector and the light source device will be omitted.

FIG. 8 is a sectional view showing a schematic configuration of a wavelength conversion element 24 of the fourth embodiment.

In FIG. 8, the component elements in common with the drawings used in above described embodiments have the same signs and the explanation thereof will be omitted.

As shown in FIG. 8, the wavelength conversion element 24 of the embodiment includes the wavelength conversion layer 30, the first substrate 31, the second substrate 32, the reflection layer 33, and the heat dissipation member 36.

Like the third embodiment, the heat dissipation member 36 is provided to surround the wavelength conversion layer 30, the first substrate 31, the second substrate 32, and the reflection layer 33. The heat dissipation member 36 has a side surface in direct contact with the respective side surfaces of the wavelength conversion layer 30, the first substrate 31, and the second substrate 32, and thereby, is thermally coupled to the respective wavelength conversion layer 30, first substrate 31, and second substrate 32. Thereby, part of the heat H of the wavelength conversion layer 30 is transmitted from the respective wavelength conversion layer 30, first substrate 31, and second substrate 32 to the heat dissipation member 36 and released from the heat dissipation member 36 to the exterior space. It is only necessary that the heat dissipation member 36 is thermally coupled to at least one of the wavelength conversion layer 30, the first substrate 31, and the second substrate 32. The rest of the configuration of the wavelength conversion element 24 is the same as that of the wavelength conversion element 13 of the first embodiment.

### Effects of Fourth Embodiment

Also, in the embodiment, the same effects as those of the first embodiment that the use efficiency of the fluorescence Y may be sufficiently secured by suppression of spreading of the output region of the fluorescence Y and lowering of the wavelength conversion efficiency, damage on the wavelength conversion layer 30, or the like may be suppressed by suppression of the temperature rise of the wavelength conversion layer 30 may be obtained.

Particularly, in the case of the embodiment, the respective wavelength conversion layer 30, first substrate 31, and second substrate 32 and the heat dissipation member 36 are thermally coupled by direct contact, not via a joint member or the like, and thereby, the temperature rise of the wavelength conversion layer 30 may be suppressed more effectively.

### Fifth Embodiment

As below, a fifth embodiment of the present disclosure will be explained using the drawings.

The basic configurations of a projector and a light source device of the fifth embodiment are substantially the same as those of the first embodiment, but the configuration of a wavelength conversion element is different from that of the first embodiment. Accordingly, the explanation of the projector and the light source device will be omitted.

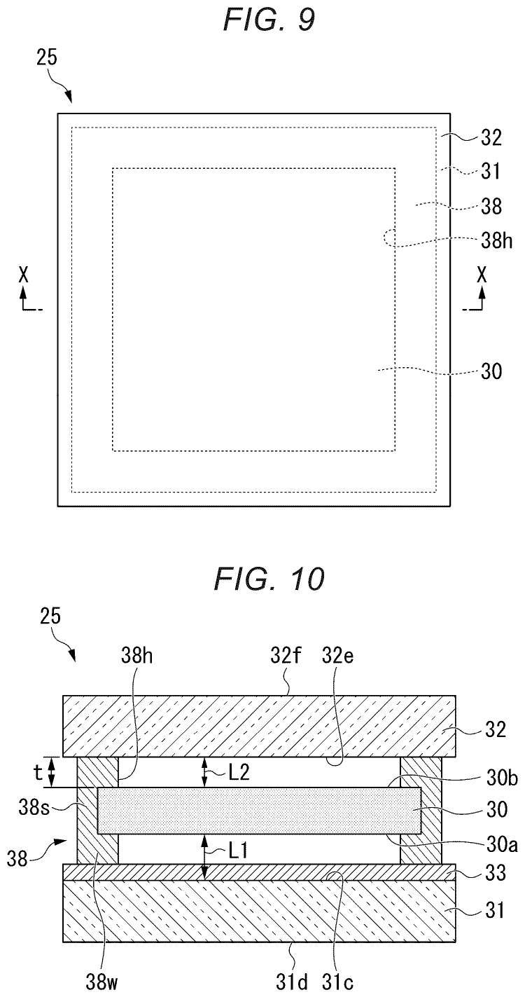

FIG. 9 is a plan view showing a schematic configuration of a wavelength conversion element 25 of the fifth embodiment. FIG. 10 is a sectional view of the wavelength conversion element 25 along line X-X in FIG. 9.

In FIGS. 9 and 10, the component elements in common with the drawings used in above described embodiments have the same signs and the explanation thereof will be omitted.

As shown in FIGS. 9 and 10, the wavelength conversion element 25 of the embodiment includes the wavelength conversion layer 30, the first substrate 31, the second substrate 32, the reflection layer 33, and a spacer 38.

As shown in FIG. 9, the spacer 38 has a rectangular frame as seen from the direction of the illumination optical axis 100ax and an opening portion 38h entered by the blue light B and outputting the fluorescence Y and the blue light B is provided at the center. Note that the spacer 38 is not necessarily provided over the entire peripheries of the wavelength conversion layer 30, the first substrate 31, and the second substrate 32, but may be provided on part of the entire peripheries of the wavelength conversion layer 30, the first substrate 31, and the second substrate 32.

As shown in FIG. 10, the spacer 38 has a side plate portion 38s and a frame portion 38w. The side plate portion 38s contacts the side surface of the wavelength conversion layer 30. The frame portion 38w extends from both ends of the side plate portion 38s along the respective first surface 30a and second surface 30b of the wavelength conversion layer 30 and respectively intervenes between the first surface 30a of the wavelength conversion layer 30 and the third surface 31c of the first substrate 31 and the second surface 30b of the wavelength conversion layer 30 and the fifth surface 32e of the second substrate 32. A thickness t of the frame portion 38w is set to 50 μm or less. Thereby, the respective distance L1 between the wavelength conversion layer 30 and the first substrate 31 and distance L2 between the wavelength conversion layer 30 and the second substrate 32 are held to be larger than 0 μm and equal to or smaller than 50 μm by the intervention of the frame portion 38w of the spacer 38. The material of the spacer 38 is not particularly limited, but it is desirable to use a metal having high thermal conductivity or the like for promotion of heat release of the wavelength conversion layer 30. The rest of the configuration of the wavelength conversion element 25 is the same as that of the wavelength conversion element 13 of the first embodiment.

### Effects of Fifth Embodiment

Also, in the embodiment, the same effects as those of the first embodiment that the use efficiency of the fluorescence Y may be sufficiently secured by suppression of spreading of the output region of the fluorescence Y and lowering of the wavelength conversion efficiency, damage on the wavelength conversion layer 30, or the like may be suppressed by suppression of the temperature rise of the wavelength conversion layer 30 may be obtained.

### Sixth Embodiment

As below, a sixth embodiment of the present disclosure will be explained using the drawing.

The basic configurations of a projector and a light source device of the sixth embodiment are substantially the same as those of the first embodiment, but the configuration of a wavelength conversion element is different from that of the first embodiment. Accordingly, the explanation of the projector and the light source device will be omitted.

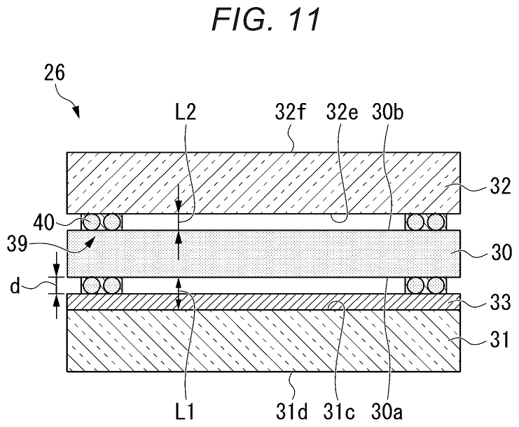

FIG. 11 is a sectional view showing a schematic configuration of a wavelength conversion element 26 of the sixth embodiment.

In FIG. 11, the component elements in common with the drawings used in above described embodiments have the same signs and the explanation thereof will be omitted.

As shown in FIG. 11, the wavelength conversion element 26 of the embodiment includes the wavelength conversion layer 30, the first substrate 31, the second substrate 32, the reflection layer 33, and a spacer 39.

The spacer 39 respectively intervenes between the first surface 30a of the wavelength conversion layer 30 and the third surface 31c of the first substrate 31 and between the second surface 30b of the wavelength conversion layer 30 and the fifth surface 32e of the second substrate 32. The spacer 39 is formed using an adhesive member including gap materials 40. The gap material 40 includes e.g., spherical hollow silica particles. A diameter d of the gap material 40 is set to 50 μm or less. Thereby, the respective distance L1 between the wavelength conversion layer 30 and the first substrate 31 and distance L2 between the wavelength conversion layer 30 and the second substrate 32 are held in a range larger than 0 μm and equal to or smaller than 50 μm. The rest of the configuration of the wavelength conversion element 26 is the same as that of the wavelength conversion element 13 of the first embodiment.

### Effects of Sixth Embodiment

Also, in the embodiment, the same effects as those of the first embodiment that the use efficiency of the fluorescence Y may be sufficiently secured by suppression of spreading of the output region of the fluorescence Y and lowering of the wavelength conversion efficiency, damage on the wavelength conversion layer 30, or the like may be suppressed by suppression of the temperature rise of the wavelength conversion layer 30 may be obtained.

The technical scope of the present disclosure is not limited to the above described embodiments, but various changes can be made without departing from the scope of the present disclosure. Further, one aspect of the present disclosure may have a configuration formed by appropriate combination of characteristic parts of the above described embodiments and modified examples.

Specific description of the shapes, the numbers, the placements, the materials, etc. of the respective component elements of the wavelength conversion element, the light source device, and the projector are not limited to those of the above described embodiments, but can be appropriately changed. In the above described embodiments, the present disclosure is applied to a fixed-type wavelength conversion element, however, the present disclosure may be applied to a rotary wheel-type wavelength conversion element. Further, in the above described embodiments, the example of the wavelength conversion element converting part of the blue light into the yellow fluorescence and outputting the white light formed by combination of the fluorescence and the other part of the blue light is taken, however, in place of the configuration, a wavelength conversion element converting all of the blue light into yellow fluorescence may be employed.

In the above described embodiments, the example in which the light source device according to the present disclosure is mounted on the projector using the liquid crystal panel is shown, however, not limited to that. The light source device according to the present disclosure may be applied to a projector using a digital micro mirror device as a light modulation device. Further, the projector does not necessarily have the plurality of light modulation devices, but may have only one light modulation device.

In the above described embodiments, the example in which the light source device of the present disclosure is applied to the projector is shown, however, not limited to that. The light source device of the present disclosure may be applied to an illumination device, a headlight of an automobile, or the like.

### Summary of Present Disclosure

As below, the summary of the present disclosure will be appended.

### APPENDIX 1

A wavelength conversion element includes a wavelength conversion layer having a first surface entered by a first light in a first wavelength band and a second surface located at an opposite side to the first surface, and converting the first light into a second light in a second wavelength band different from the first wavelength band, a first substrate placed to face the first surface and transmitting the first light, and a second substrate placed to face the second surface and transmitting the second light, wherein the wavelength conversion layer and the first substrate are not in optical contact, and the wavelength conversion layer and the second substrate are not in optical contact.

According to the configuration of Appendix 1, use efficiency of the second light may be sufficiently secured by suppression of spreading of an output region of the second light.

### APPENDIX 2

In the wavelength conversion element according to Appendix 1, the wavelength conversion layer and the first substrate are apart from each other, the wavelength conversion layer and the second substrate are apart from each other, and 0<L1≤50 μm and 0<L2≤50 μm, wherein a distance between the wavelength conversion layer and the first substrate is L1 and a distance between the wavelength conversion layer and the second substrate is L2.

According to the configuration of Appendix 2, heat of the wavelength conversion layer may be transmitted to the respective first substrate and second substrate, and thereby, in addition to the sufficient securement of the use efficiency of the second light, lowering of the wavelength conversion efficiency, damage on the wavelength conversion layer, or the like may be suppressed by suppression of the temperature rise of the wavelength conversion layer.

### APPENDIX 3

In the wavelength conversion element according to Appendix 1 or Appendix 2, a refractive index of the second substrate is equal to or larger than 1.5.

According to the configuration of Appendix 3, a refraction angle when the second light enters the second substrate is larger than that when the refractive index of the second substrate is smaller than 1.5, and spreading of the second light output from the second substrate may be made smaller. Or, if the spreading of the output fluorescence equal to that when the refractive index of the second substrate is smaller than 1.5 is acceptable, the second substrate may be made thicker and the heat dissipation of the second substrate may be increased.

### APPENDIX 4

The wavelength conversion element according to any one of Appendix 1 to Appendix 3 further includes a reflection layer provided between the wavelength conversion layer and the first substrate, and transmitting the first light and reflecting the second light.

According to the configuration of Appendix 4, the second light output from the wavelength conversion layer toward the first substrate may be reflected by the reflection layer and returned to the wavelength conversion layer, and thereby, the second light output from the second substrate may be increased.

### APPENDIX 5

In the wavelength conversion element according to Appendix 4, the reflection layer is provided on the first surface of the wavelength conversion layer.

According to the configuration of Appendix 5, the second light is reflected by the reflection layer, not output from the first surface of the wavelength conversion layer to an exterior space, and thereby, a loss of the second light may be minimized.

### APPENDIX 6

In the wavelength conversion element according to Appendix 4, the reflection layer is provided on a surface of the first substrate facing the first surface.

According to the configuration of Appendix 6, the surface of the first substrate facing the first surface has higher flatness than that of the first surface of the wavelength conversion layer, and thereby, the reflection layer having a desired property is easily formed.

### APPENDIX 7

In the wavelength conversion element according to any one of Appendix 1 to Appendix 6, thermal conductivity of the first substrate is larger than thermal conductivity of the wavelength conversion layer, and thermal conductivity of the second substrate is larger than thermal conductivity of the wavelength conversion layer.

According to the configuration of Appendix 7, heat of the wavelength conversion layer may be efficiently released to the exterior space from the respective first substrate and second substrate.

### APPENDIX 8

In the wavelength conversion element according to any one of Appendix 1 to Appendix 7, 0<Ra<1 μm, wherein arithmetic mean roughness of the first surface and the second surface of the wavelength conversion layer is Ra.

According to the configuration of Appendix 8, the configuration in which, even when the wavelength conversion layer are brought into contact with the respective first substrate and second substrate, the wavelength conversion layer and the respective first substrate and second substrate are not in optical contact may be realized.

### APPENDIX 9

The wavelength conversion element according to any one of Appendix 1 to Appendix 8 further includes a heat dissipation member thermally coupled to at least one of the first substrate, the wavelength conversion layer, and the second substrate.

According to the configuration of Appendix 9, the wavelength conversion element includes the heat dissipation member, and thereby, the temperature rise of the wavelength conversion layer may be suppressed more effectively.

### APPENDIX 10

A light source device includes the wavelength conversion element according to any one of Appendix 1 to Appendix 9, and a light emitting element outputting the first light to be entered into the wavelength conversion element.

According to the configuration of Appendix 10, the light source device having the higher use efficiency of the second light may be obtained.

### APPENDIX 11

A projector includes the light source device according to Appendix 10, a light modulation device modulating a light containing the second light output from the light source device according to image information, and a projection optical device projecting the light modulated by the light modulation device.

According to the configuration of Appendix 11, the projector with higher efficiency may be obtained.

What is claimed is:

1. A wavelength conversion element comprising:
a wavelength conversion layer having a first surface entered by a first light in a first wavelength band and a second surface located at an opposite side to the first surface, and converting the first light into a second light in a second wavelength band different from the first wavelength band;
a first substrate facing the first surface and transmitting the first light; and
a second substrate facing the second surface and transmitting the second light, wherein
the wavelength conversion layer and the first substrate are not in optical contact, and
the wavelength conversion layer and the second substrate are not in optical contact.

2. The wavelength conversion element according to claim 1, wherein
the wavelength conversion layer and the first substrate are apart from each other,
the wavelength conversion layer and the second substrate are apart from each other, and
0<L1≤50 μm and 0<L2≤50 μm, wherein a distance between the wavelength conversion layer and the first substrate is L1 and a distance between the wavelength conversion layer and the second substrate is L2.

3. The wavelength conversion element according to claim 1, wherein
a refractive index of the second substrate is equal to or larger than 1.5.

4. The wavelength conversion element according to claim 1, further comprising a reflection layer provided between the wavelength conversion layer and the first substrate, and transmitting the first light and reflecting the second light.

5. The wavelength conversion element according to claim 4, wherein
the reflection layer is disposed on the first surface of the wavelength conversion layer.

6. The wavelength conversion element according to claim 4, wherein
the reflection layer is disposed on a surface of the first substrate facing the first surface.

7. The wavelength conversion element according to claim 1, wherein
thermal conductivity of the first substrate is larger than thermal conductivity of the wavelength conversion layer, and
thermal conductivity of the second substrate is larger than thermal conductivity of the wavelength conversion layer.

8. The wavelength conversion element according to claim 1, wherein
0<Ra<1 μm, wherein arithmetic mean roughness of the first surface and the second surface of the wavelength conversion layer is Ra.

9. The wavelength conversion element according to claim 1, further comprising a heat dissipation part thermally coupled to at least one of the first substrate, the wavelength conversion layer, and the second substrate.

10. A light source device comprising:
the wavelength conversion element according to claim 1; and
a light emitting element outputting the first light to be entered into the wavelength conversion element.

11. A projector comprising:
the light source device according to claim 10;
a light modulation device modulating a light containing the second light output from the light source device according to image information; and
a projection optical device projecting the light modulated by the light modulation device.
